(19) United States
(12) Patent Application Publication
(10) Pub. No.: US 2005/0001041 A1
(43) Pub. Date: Jan. 6, 2005

(54) Cargo security

(76) Inventors: Andrew J.J. McCarthy, Bourton-on-the-Water (GB); Charles P. Gates, Bourton-on-the-Water (GB)

Correspondence Address: GODFREY & KAHN S.C., 780 NORTH WATER STREET, MILWAUKEE, WI, 53202, US

(21) Appl. No.: 10/749,165

(22) Filed: Dec. 30, 2003

Related U.S. Application Data
(63) Continuation-in-part of application No. 09/502,274, filed on Feb. 11, 2000, now abandoned.

(30) Foreign Application Priority Data
May 11, 1999 (GB) 9910754.2
Sep. 14, 1999 (GB) 9921658.2

(51) Int. Cl. G06K 19/06

(52) U.S. Cl. 235/492

(57) ABSTRACT

A cargo closure for sealing a cargo item such as a piece of luggage in a closed condition is disclosed. The cargo closure comprises a permanently closable tie and a data carrying member which may be formed as an integral plastics molding. The tie includes a strap and a base member. The strap includes barbs which engage a flexible pawl member located within a hole through the base member through which a free end of the strap is inserted and tightened after being attached to the cargo. The data carrying member may carry a person's name and address and is foldable to selectively to conceal or expose those data, and it may also carry an alphanumeric string or a bar code for identification purposes. Other embodiments of the invention may include strips of conductive material in the tie and base member which are connected to a smart card attached to the data carrying member for communicating with electronic equipment on the cargo item.

### RELATED APPLICATION

This application is a continuation in part application of, and claims priority to, U.S. patent application Ser. No. 09/502,274 filed Feb. 11, 2000 which claims priority from GB Patent Application No. 9910754.2 filed on 11 May 1999 and GB Application No. 9921658.2 filed on 14 Sep. 1999, all of which are hereby incorporated in their entireties for all purposes.

### BACKGROUND OF THE INVENTION

This invention relates to cargo security, and it has particular, but not exclusive, reference to the security of airline cargo, for example the luggage of passengers.

There is an ever increasing awareness of security problems associated with luggage and other cargo items which are to be carried by an aircraft or indeed any other vehicle such as ship, train, or land vehicle particularly where international travel is concerned. There is a problem associated with theft from luggage while it is in the care of the transport agency, (air line, shipping line, railway authority etc.) but particular problems relate to the carrying of explosive devices onto aircraft or other vehicles and the smuggling of illicit drugs. The problem will be discussed in the particular context of air travel where it is perhaps most serious, but it will be appreciated that analogous problems arise in many other fields.

Because of the possibilities of terrorist activity it is common practice, and perhaps universal, for an airline passenger to be asked, when checking in for a particular flight, whether that passenger packed his luggage himself and whether he has left it unattended since. Now while it is true that most people do indeed pack their own luggage, it is by no means uncommon for the luggage to be left unattended. For example it is usual practice for a hotel to require guests to check out before midday on the day they are leaving, so morning packing is the general rule. This leaves the departing guest with the problem of what to do with his luggage between checking out and departing for the airport. If the guest has an evening flight to catch, he may make use of a common facility offered by many hotels and leave his luggage in an allegedly secure room during the afternoon. On departure, the traveler may well board a coach for the airport before his luggage has been stowed in the coach's luggage compartment. In either case, the traveler may be reluctant to admit leaving his luggage unattended despite the fact that there has been an opportunity, however brief, to place some unlawful material in his luggage. The consequence of such an admission would be that the passenger would have to open and check his luggage at the check-in counter causing delays to other passengers. It is likely that a combination of laziness and lack of forethought would prevent such an examination prior to arrival at the check-in counter.

The prudent traveler will secure his luggage with a lock of some kind, perhaps a padlock which is the usual method of securing a light-weight zipped case such as is commonly used when flying. However padlocks used for securing luggage are overwhelmingly of one of two designs: one is a small brass padlock and the other a small chromium plated padlock. It would be very easy to cut away such a lock with an ordinary pair of pliers, insert a package of unlawful material, and replace the lock with another one of identical appearance. The disturbance to the luggage would be undetectable until the passenger tried to open it, and he might well not do so before flying. Again, knowledge of human nature suggests that the passenger would be reluctant to admit the possibility that his luggage had been tampered with.

Further, it is common practice if an arriving international traveler is stopped at an airport customs inspection post for the Customs Officer to ask the traveler whether a piece of luggage belongs to him, whether he packed it himself and whether he has left it unattended. Many people seem to answer “no” to the last question despite the fact that they have had no control over the luggage since it was checked in before the flight, and that it has certainly been handled by others at two different airports. Other related security problems may also occur during transit of cargo.

A particular problem with airline luggage, which is also applicable to other methods of transport, is that passengers are relieved of bulky luggage items and these are consigned to the hold of an aircraft. The destination of the luggage item is fixed to it at check-in and generally not checked by its owner. It may therefore be relatively easy for luggage to become misdirected despite the best efforts of aircraft staff. Airline operators deal with a large amount of luggage every day, all going to different locations, and there is an ever present risk that passengers and their items of luggage may travel on different aircraft.

If a piece of cargo is misdirected-directed to a store with many other similar pieces it may be difficult to identify individual pieces of cargo and match them to their owners. The cargo may therefore become permanently lost.

If the cargo item is a piece of traveler's luggage, it is common practice for it to carry a luggage label bearing the traveler's name and address in order to avoid that the luggage become permanently lost. But this has the disadvantage that the label may easily be inspected by persons loitering at an airport who may then infer that the address in question will be unoccupied for a period, which has obvious adverse implications for home security.

Furthermore when cargo is transported several pieces of paperwork are often involved. These papers may conveniently be referred to as travel documents. A travel document may comprise any document relating to travel and includes a passenger ticket in the case of luggage items. Other examples of travel document include one or more of: a bill of lading, a cargo manifest and/or a delivery note in the case of industrial cargo items.

It is an object of this invention to address the problems outlined above. In particular, it is an object of this invention to provide a readily identifiable means for determining whether a piece of cargo or luggage has been tampered with. This may comprise a cargo closure for identifying and securely closing cargo.

It is a further object of this invention at least in its preferred embodiments to ensure that such means is affordable and may be conveniently manufactured in large quantities; and is usable on a wide variety of cargo items.

It is a further object of this invention in some preferred embodiments to protect the personal details of travelers from casual observation.

It is a further object of this invention in some preferred embodiments to alleviate problems associated in tracking luggage and to provide a simple and secure system for doing so.

It is a further object of some preferred embodiments of this invention to alert travelers to attempts to tamper with their luggage.

It is a further object of this invention that the system be commercially attractive and that in some preferred embodiments it may be able to generate revenue for travel or cargo operators.

It is a further object of some preferred embodiments of this invention that the system be saleable in a manner suited to the particular needs of the travel and cargo industries.

### SUMMARY OF THE INVENTION

This invention provides a cargo closure for sealing a cargo item in a closed condition comprising a tie and a data carrying member, the tie being permanently closable in the sense that once closed, the tie cannot easily be opened without rupturing the tie, and being adapted to secure the data carrying member to a said cargo item, wherein the data carrying member comprises a flag having a median zone of weakness about which the flag is foldable selectively to conceal or reveal data carried thereby.

The expression “permanently closable tie” is used herein to denote a tie which may be closed, but not thereafter opened without destroying the tie. Examples of such ties are widely available as cable-ties, for securing together bundles of electrical wiring.

Because the tie cannot be opened without destroying it, it provides a tamper evident seal, and any opening of the cargo item will be immediately apparent. To militate against a substitution of an identical replacement tag after unauthorized tampering, such a tie could be manufactured in a wide variety of different patterns or colors and/or carrying serial numbers which would generally be unique or different visually legible data. The foldable flag enables data on the data carrier to be protected from casual inspection. If the cargo container is a luggage item belonging to a traveler the traveler's personal details may be entered on the inside of the fold so that they cannot easily be seen, increasing the traveler's peace of mind and domestic security whilst the traveler is away from home. In some embodiments the cargo closure may be arranged to hold details that do not directly allow the owner to be identified and/or his/her address to be determined by any unauthorized persons such as a burglar or the like. For example the cargo closure may be arranged to hold flight details. Providing only such information is advantageous since it may help to increase that person's security and/or the security of his/her home.

In a preferred embodiment releasable snap-fit means are provided for holding the foldable data carrying member in folded condition. Any enfolded data will then be securely protected against casual observation. Data may for example be carried by a label adhered to the data carrying member.

While the invention has particular reference to tags for securing the hold luggage of airline passengers, tags in accordance with the invention may be used for other purposes, such as for identifying cabin luggage and indeed as identification tags and/or closure seals for any other article.

Preferably the tie comprises a stem and a member having an opening into which the stem may be inserted, the stem and opening comprising co-operating surface formations adapted and arranged to allow insertion of the stem into the opening and to resist its withdrawal therefrom. This allows speedy and convenient fastening of the device to the cargo container. A stem-type formation is insertable through a wide variety of shackles and other formations on a said cargo item, whilst co-operating surface formations can provide a secure lock for a low manufacturing cost.

In a preferred embodiment the stem comprises a zone of weakness. This may enable the closure to be ruptured by hand so that the cargo item may be opened on arrival at its destination. This is particularly advantageous if the ultimate tensile strength of the zone of weakness is below the force required to withdraw the stem from the opening. Rupture of the stem provides a readily visible indication that the cargo item may have been tampered with. The stem preferably also comprises a stop means operative to limit insertion of the stem into the opening.

Advantageously the surface formations comprise a series of axially spaced ribs of a generally saw-tooth shaped profile which extends along said stem. These surface formations may be arranged to extend around the surface area of the stem in substantially circular manner thus increasing the difficulty of withdrawing the stem from the opening.

Advantageously, a said co-operating surface formation on said opening is spaced from each end of that opening by an amount which is greater than the axial spacing of said ribs. The opening may be arranged as a close fit around the ribs and the adoption of this feature will tend to ensure that access to that co-operating surface is blocked, thus increasing the difficulty of opening the tie without breaking it.

Preferably the tie and the data carrying member are constituted by an integral molding of thermoplastics material. They are thus convenient to manufacture in bulk and may be readily disposed of. Lockable surface formations may thus be easily molded as part of the manufacturing process.

In some preferred embodiments of the invention, the folded data carrying member constitutes a pocket for retaining a removable data carrier. The removable data carrier may comprise magnetic storage means and/or integrated circuit means. In a preferred embodiment the separate data carrier comprises a travel document.

The data inscribed upon the carrier may take various forms, and each data element may be inscribed in one or more than one of these forms. Preferably some or all of the data are in the form of one or more visually legible characters. The data may therefore easily be read by, for example, cargo handlers. Some or all of the data may additionally or alternatively be in machine readable form. This will be convenient when the cargo must pass through automated handling or control systems.

This invention includes a travel pack comprising a travel document and at least one cargo closure for sealing a cargo item in a closed condition comprising a tie and a data carrying member, the tie being permanently closable in the sense that once closed, the tie cannot easily be opened without rupturing the tie and being adapted to secure the data carrying member to the cargo item, wherein the data carrying member comprises a flag having a median zone of weakness about which the flag is foldable selectively to conceal or reveal data carried thereby.

The travel document may be any of a wide range of items of paperwork that are necessary to or advantageous for facilitating travel or the transport of goods. In a particularly preferred embodiment the travel document is a travel ticket. However the travel document may additionally or alternatively contain a wide range of information, for example:
(a) ownership information
(b) an identification reference indicator
(c) operator information
(d) advertising information
(e) cargo handling information
(f) cargo contents information
(g) cargo delivery information
(h) passenger travel information

Of these various types of information passenger travel information may include vehicle type and departure information, car parking tickets, information about travel route and changes to be made onto different forms of transport. Ownership information may include any of: the name of the owner or consignor or consignee of the cargo or the address of the owner or consignor or consignee of the cargo.

Cargo handling information includes any information concerning: the origin, the destination and the route that should be taken by the item of cargo; the route actually taken by the cargo; details of companies and/or people responsible for the safe transit of the cargo; and/or a cargo manifest or delivery note containing details of the cargo contents.

Cargo contents information includes any information comprising: the nature of the cargo; the quantity of cargo being transported; any associated cargo containers; whether the cargo contents are fragile; sensitive; or hazardous; the nature of any hazard and instructions for dealing with accidental release of the contents of the cargo container.

Cargo delivery information may include documents such as one or more of a bill of lading, a cargo manifest and/or a delivery note in the case of industrial cargo items.

Finally operator information may include the name and address of the company or companies responsible for the safe transit of the cargo or the passenger, details of which companies take over responsibility and at what points in the journey.

This invention extends to a cargo item comprising two components which are relatively movable to open the cargo item, and a cargo closure for sealing the cargo item in a closed condition, the cargo closure comprising a tie and a data carrying member, the tie being operable to secure together the data carrying member and said two relatively movable components in such manner that said two components cannot be separated, and thus the cargo item cannot be opened, without rupture of the tie, wherein the data carrying member comprises a flag having a median zone of weakness about which the flag is foldable selectively to conceal or reveal data carried thereby.

In a preferred embodiment at least one of the relatively moveable components comprises part of a zip fastening device. Zips are a common form of fastening device and usually contain pull tabs and/or “kissrings” having openings through which the cargo closure tie may be inserted.

This invention also provides a cargo security system comprising a memory means adapted to store data relating to a cargo item, and a cargo closure for sealing a cargo item in a closed condition; the cargo closure comprising a tie and a data carrier which comprises a flag adapted to carry visually legible data and having a median zone of weakness about which the flag is foldable selectively to conceal or reveal any such data carried thereby, the tie being permanently closable in the sense that once closed the tie cannot be opened easily without rupturing the tie, and being adapted to secure the data carrier to the cargo item; the data carrier bearing a reference location indicator which gives an indication of the address, in said memory means, of data pertaining to the cargo item to which that data carrier is, or is intended to be, affixed.

In an advantageous embodiment of this form of the invention the reference location indicator is visually legible.

Preferably the memory means comprises a computer and the cargo closure comprises a reprogrammable memory means and means is provided for transferring data between the memory means of the computer and the memory means of the cargo closure. This enables the progress of the cargo container to be continually tracked. Information stored in the memory means of the cargo closure may identify the cargo closure and alert operators and handlers as to the nature of its contents, its delivery route and timetable, etc. The information is transmitted onto a portable data receiver or computer carried by a cargo handler or supervisor. It may then be compared to information stored in a central database which specifies which cargo containers should be in the warehouse or depot.

The cargo closure may further comprise activating means for the memory means, and deactivating means for the memory means in order to define the period in which data may be recorded. This prevents wastage of recording time if the container is stored after securing the container but before the journey begins. The activation may occur automatically when the cargo closure is registered by its first handler.

Preferably the cargo closure of the cargo security system further comprises a processor means operable to: periodically compare the planned information to the updated information in the cargo closure; store the results of the comparison in the cargo closure; and an indicator means operable to provide an indication if the results of the comparison are outside pre-specified temporal parameters. The cargo closure or the cargo container itself can thus alert its handlers to delays or deviations occurring in its schedule.

In a preferred embodiment the indication comprises broadcasting the location of the cargo container from the location of the cargo container. The cargo closure may be operatively associated with a GPS type system which is equipped to broadcast its location so that it may be found by a person who is searching for it when suitably controlled by the cargo closure.

This invention includes a cargo closure for sealing a cargo item in a closed condition comprising a tie and a data carrying member which comprises a flag adapted to carry visually legible data and having a median zone of weakness about which the flag is foldable selectively to conceal or reveal any such data carried thereby, the tie being permanently closable in the sense that once closed, the tie cannot easily be opened without rupturing the tie and being adapted to secure the data carrying member to the cargo item, the data carrying member further comprising memory means adapted to store data in digital form.

The signaling means may comprise any method of alerting a person or, system of the trigger event or recording the presence of a trigger event. It may, for example emit a sonic wave. In this case the signal wavelength of this wave is preferably in the humanly audible range. Alternatively or additionally the signaling means may emit an electromagnetic wave. In this case the signal wavelength of this wave may be in the humanly visible range. In an alternative or additional embodiment the electromagnetic wave may be roughly 13.85 MHz. Such a frequency is advantageous because it corresponds to an internationally agreed frequency for luggage/baggage handling.

The trigger means can be designed to respond to tampering with the cargo. Alternatively it may arise as the result of interrogation of the cargo. In this case the trigger may comprise an activating signal generated by, for example a warehouser who is sweeping the activating signal across an array of cargo in order collate information pertinent to that cargo.

The trigger may, for example, comprise a circuit element which will break on rupture of the tie. Thus if the tie is tampered with the electrical operation of the tie is disturbed to trigger an alarm system which may alert a person nearby. This type of system is inexpensive and relatively easy to manufacture.

Alternatively or additionally the trigger could comprise a clock which indicates a time by which the cargo should have been delivered so that the cargo closure emits an alarm if it has been delayed.

Preferably an electromagnetic wave transceiver is provided for triggering the signaling means. In this case the trigger may comprise an activating signal generated by, for example a warehouser who is sweeping the activating signal across an array of cargo in order collate information pertinent to that cargo. A radio receiver, infra-red detector or ultra-sonic wave detector may alternatively or additionally provide such triggering.

This invention extends to a cargo security system comprising a plurality of such cargo closures each attachable to a respective cargo item containing part of a cargo consignment wherein each transmitter, each receiver, each programmable memory, each clock and each processor are separately either associated with the cargo closure or the cargo item and the system periodically reaffirms that each cargo item remains with the rest of the cargo consignment, stores this information and provides an indication if the cargo consignment is no longer complete.

The memory means may conveniently store such data as those mentioned earlier.

In a preferred embodiment the memory means comprises a magnetic storage medium. Advantageously the memory means is reprogrammable. This enables the data on the memory means to be updated in transit.

Such a cargo closure may further comprise: a transmitter adapted to emit a signal containing data; a receiver adapted to receive a signal containing data; a clock; and a processor adapted to control the transmitter, the clock and the memory means.

Preferably the cargo closure is operatively associated with: a transmitter adapted to emit a signal containing data; a receiver adapted to receive a signal containing data; a clock; and a programmable memory adapted to store the data; and the cargo closure comprises: a processor adapted to control the transmitter, the clock and the memory. The components that the cargo closure is operatively associated with may be stored on the cargo container. These components are currently relatively bulky and expensive. Providing such components on the cargo container with the control circuitry or just sensing elements on the cargo closure enables the cargo closure to be made relatively inexpensive and disposable. One cargo closure may be operatively associated with one or a plurality of cargo containers and one cargo container may be operatively associated with one or a plurality of cargo closures. This may be achieved by appropriate programming of the cargo closures and/or the cargo containers.

In a preferred embodiment of a cargo closure operatively associated with the above components the clock, the processor and the memory means are located on an integrated circuit and the integrated circuit is located on a smart card, the smart card further comprising input and output means. The smart card may be removably connectable to the cargo closure. In this case its electrical and mechanical connections may be derived from the same mechanism.

Furthermore, in such a cargo security system which comprises a plurality of operatively associable cargo closures each may preferably be attachable to a respective cargo item containing part of a cargo consignment wherein each transmitter, each receiver, each programmable memory, each clock and each processor are separately either associated with the cargo closure or the cargo item and the system may periodically reaffirm that each cargo item remains with the rest of the cargo consignment, store this information and provide an indication if the cargo consignment is no longer complete.

If regular transmissions are not received, thus signifying that the cargo containers have been separated, an alarm may be sounded, and the information noted by the cargo closure. This provides the owner or sender of the cargo information about when a cargo consignment has been separated and some control over how cargo consignments are handled by airline operators.

This invention also extends to a method of advertising comprising displaying advertising material on a data carrier attached to a cargo closure, the cargo closure comprising a permanently closeable tie and the data carrier connecting the cargo closure to a cargo container. The advertising material may be on a label which is stuck to the data carrier. The advertising material may be provided as a printed carrier, which may comprise a pamphlet, a booklet or the like.

Alternatively or additionally the advertising material may be electronically displayed. In this case the advertising material may be reprogrammable and thus updateable at different points in the journey to reflect the different operators handling the material and/or other relevant factors such as the geographical location of the cargo closure and container.

This invention further extends to a method of doing business, the method comprising: displaying a cargo closure with any or all of the characteristics detailed above on a stand, the stand being part of an exhibition oriented toward the travel or cargo industries; and selling the cargo closure. The cargo closure may be provided at a point of sale dispenser, which may be provided in the vicinity of a check-in counter or the like. Preferably details of the cargo tracking systems detailed above, or the cargo anti-tampering systems detailed above or the cargo security systems detailed above may also be displayed at such a stand and the systems sold to travel or cargo handling industry executives.

The invention also extends to a method of advertising, or generating advertising revenue which comprises applying to an outer face of a said data carrier of a cargo closure, a trade mark or logo.

### BRIEF DESCRIPTION OF THE DRAWINGS

Preferred embodiments of the invention will now be described by way of example only with reference to the accompanying drawings in which:

FIGS. 1 and 2 are respectively front and rear views of a cargo closure in accordance with this invention;

FIG. 3 shows the closure folded closed;

FIG. 4 shows schematically a second embodiment of a cargo closure in accordance with this invention showing an attached smart card;

FIG. 5 shows schematically a top perspective view of a third embodiment of a cargo closure in accordance with this invention; and

FIG. 6 shows schematically a side sectional view of the embodiment of FIG. 5.

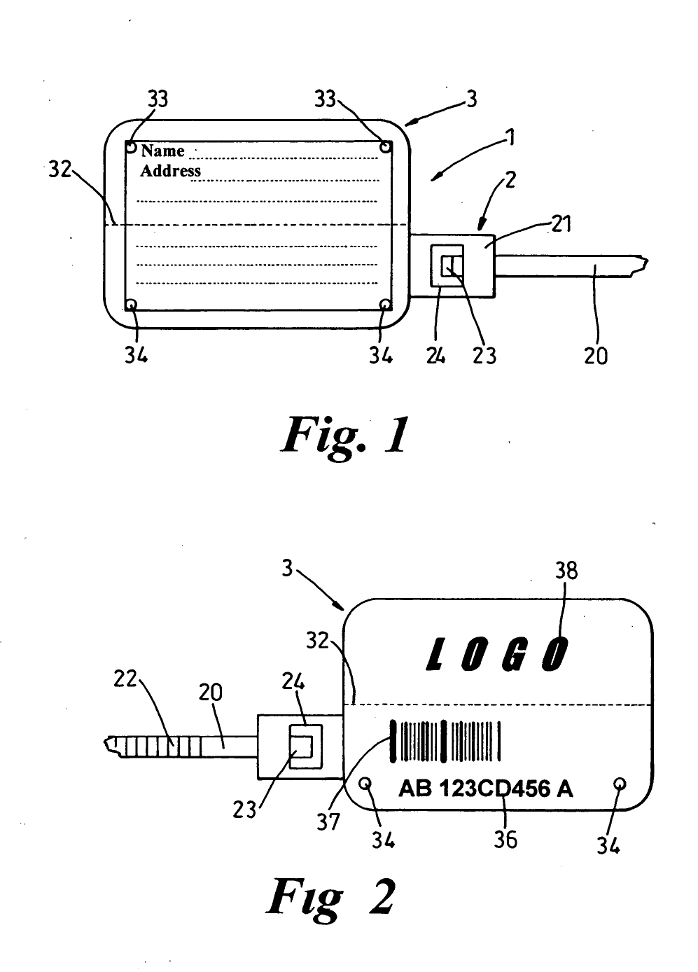

### DETAILED DESCRIPTION OF PREFERRED EMBODIMENTS

In the drawings, a cargo closure 1 comprises a permanently closable tie 2 attached to a data carrying member 3. The tie 2 and data carrying member 3 are suitably formed as an integral molding of a polymeric material. The polymeric material used may suitably be polypropylene, though other materials could be used, such as a nylon™ or the like.

The tie 2 comprises a strap 20 and a base member 21. The rear face of the strap 20 carries barbs 22 which engage with a flexible pawl member 23 located within a hole 24 through the base member 21 through which a free end of the strap 20 may be passed and tightened. The strap may be passed through convenient parts of the cargo item, for example through holes in pull-tabs of a double zip closure, so that it is secured closed. The data carrying member 3 bears on its front face space 31 for the insertion of a data carrier bearing a passenger's or consignee's name and address. This space may be constituted by a textured surface of the data carrying member which is adapted to receive writing e.g. from a ball-point pen. If desired, such a textured surface could be overprinted with a security pattern which would make evident any attempt to erase any data written to that surface. An indication of the type of data to be written to any part of that space could for example be laser-etched into the surface of the carrier. A suitable laser-etching machine is available from Alltec UK Limited, Buckingham Road Industrial Estate, Brackley, Northants NN13 7BE, England under designation FK25 Laser Marking System.

Alternatively, a data carrier such as an adhesive label of paper or other suitable material may be supplied. Such an adhesive label could be supplied separately typing or printing of the address details, or the address details could be pre-printed onto the label, for example by a travel ticket supplier.

The data carrying tag or flag member comprises a hinge or fold line 32 and pop-studs 33 and co-operating holes 34 by which the tag may be folded and held closed in order to conceal such name and address details from casual observers. This is intended to alleviate a common fear of holidaymakers that displaying one's name and address on luggage labels is in effect an advertisement to potential thieves that one's home will be unoccupied for some days or weeks. Such fold line is shown horizontal. Depending on the shape of the data carrier, it may be more appropriate to have the fold line vertical.

If desired, the pop-studs 33 may be barbed in order permanently to close the folded tag. This is especially useful if there is a separate data carrier which is enfolded within the tag and which only needs to be inspected at the destination of the cargo item, or where such a data carrier has monetary value, or where the data is of a confidential nature.

The rear face 35 of the data carrying member suitably carries an alphanumeric string such as indicated at 36. This may be a string which is unique to a particular cargo item, or a plurality of different cargo closures may be produced with a same alpha-numeric string 36 which is unique to a particular consignment or to a traveler or group of travelers. For example a family or other group of travelers who book a flight at the same time could be allocated a common alpha-numeric string 36. Such an alpha-numeric string could be used as a reference location indicator identifying the location in a data storage facility of further data relating to the cargo item or items. An alpha-numeric string such as 36 could be laser-etched, or molded into the cargo closure during its manufacture.

The rear face 35 of the data carrying member also suitably carries a machine readable data string such as a bar code 37. This may again be a string which is unique to a particular cargo item, or a plurality of different cargo closures may be produced with a same bar code 37 which is unique to a particular consignment or to a traveler or group of travelers, and again such a bar code could be used as a reference location indicator identifying the location in a data storage facility of further data relating to the cargo item or items. Alternatively, such bar code could be an encoding of data relating to a particular flight or other departure on which the cargo item was booked. Such bar code could be present on the data carrier when supplied to the customer, or it could be applied as an adhesive label, for example at a passenger check-in position.

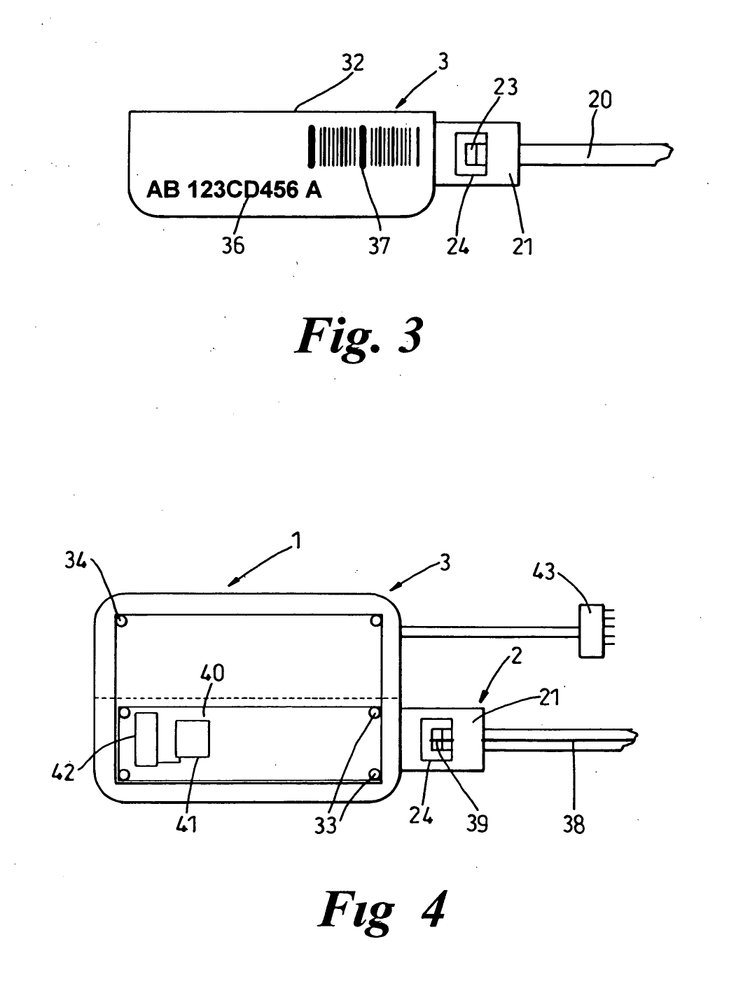

Such an alpha-numeric string 36 or bar code 37, or both, could be duplicated on the rear face of the data carrying member so that it or they were readable from both sides of the closure when its data carrying member is in the closed condition as shown in FIG. 3

The data carrying member may also carry a logo 38 of some trading organization, for example an airline or a travel tour operator, in which case it could serve as a gross identifier for travelers' luggage. Such a logo 38 could alternatively be an advertising slogan or Trade Mark which is associated with an advertising campaign rather than specifically with the journey being undertaken. In FIG. 4 a second embodiment of a cargo closure 1 comprising a permanently closeable tie 2 and a data carrying member 3 is shown, molded from a suitable polymeric material. Inserted into and running through a strap of the tie 2 is a strip 138 of a conducting material. Another strip 39 of conducting material is also incorporated into a base member 21 so that when a free end of the strap is passed through a hole in the base member 21 and tightened the two conducting strips 138, 39 connect. A conducting pathway is thus formed.

A removable smart card 40 may be attached to the data carrier 3 by snapping respective holes in the smart card 40 over conductive studs 33 in the data carrier 3. Incorporated into the smart card 40 is an electronic chip 41. This contains a central processing unit, a clock, a read only memory and a random access memory. This smart card 40 is powered by solar panels 42.

Two of the conductive studs 33 in the data carrier 3 are electrically connected to the strips of conducting material 138, 39. A further two are electrically connected to a socket on the cargo container via a plug 43. In this way the smart card can communicate with the conducting strips and communicate with and control associated electronics on a cargo container.

The associated electronics includes a global positioning system (GPS) unit, a radio frequency transmitter and a radio frequency receiver via a bus. It also includes an accelerometer sensor, a radio alarm, a buzzer alarm and a light emitting diode (LED). These electronics are powered by a separate battery also contained within the cargo container.

When the cargo closure 1 is attached to the cargo container it sends an energizing signal to the associated electronics to turn the associated electronics on.

The random access memory is programmed before the cargo closure is closed. The sender of the cargo (or alternatively a travel agent for passenger luggage) enters details regarding the cargo on a personal computer (p.c.) running appropriate databasing, encoding and tracking software. This p.c. controls a radio frequency transmitter, used to communicate with a handheld portable device.

Data regarding a large number of cargo containers may be downloaded into the portable electronic device. This contains a transmitter which in turn is used to send an encoded signal to a receiver on individual cargo containers. Once the cargo closure 1 has been attached to the cargo container and plugged in it the hand-held electronic device may be used to send data regarding the cargo container to the random access memory in the electronic chip 41.

A warehouser uses the handheld electronic device to generate an encoded signal, which is transmitted to the cargo closure. The signal contains data which identify it as a programming signal for a particular cargo closure. When received this is decoded by the CPU and if the cargo closure is the one designated by the signal, the data contained in the signal are written by the CPU to the random access memory.

These data include the name and address of the cargo owner, the sender, and the receiver as well as details of the route that the cargo will take. The names and addresses of the companies responsible for handling the cargo are also written into the random access memory, together with details of any other cargo closures that the container is being dispatched with. The timescale of the journey, including any different stages, forms part of the data transmitted. Furthermore the contents of the container, the nature of these contents and any special handling instructions are written into the random access memory. The chip 41 may be programmed to checks the nature of the contents and will light the LED if the cargo contents are hazardous. If the contents are perishable the best before date will be noted by the chip 41 and an event trigger for an alarm set up so that the buzzer may be sounded if the contents are delayed for too long.

The warehouser then closes the cargo closure and depresses a button on the smart card in order to activate the security features on the cargo closure 1. The cargo closure 1 then starts its anti-tampering and tracking operations described further below. Alternatively the smart card 40 may be activated by the act of folding over the data carrier 3 and connecting the conductive studs 33 to the respective pair of metal studs on the other half of the data carrier 3. These may form a conducting pathway that will change the resistance between conductive studs 33 in way which is detectable by the CPU.

Upon closure of the cargo carriers the existence of the conducting pathway formed by the conducting strips 138, 39 is also registered by chip incorporated into the data carrier.

The cargo container is then dispatched. The first handling company transmits a coded signal to the chip when the cargo container is handed over to it. Similarly the second handling company registers their responsibility for the cargo with the chip. The chip records the date and time of handover. The chip regularly compares the current date and time with its expected date and time for finishing that stage of the journey and with a best before date if the goods are perishable. If these are exceeded by a pre-determined amount it will generate an alarm.

Employees of the handling companies may record the details of the cargo containers that they are carrying. A small personal computer is used to generate an activating signal which is recognized by all cargo closures. Upon emission of this signal the cargo closure downloads selected fields of its data via the electronic transmitter to the personal computer. If the cargo closure is delayed or lost it will also sound an alarm when activated.

During the journey the chip also continually measures the voltage of the pathway. Unexpected severing of the conducting pathway causes an open circuit. The chip then consults the GPS system. If it is at its delivery location it will not sound the buzzer. Otherwise it is probable that the cargo closure has been tampered with and the chip activates the buzzer alarm, and to flash the light emitting diode on and off. It will also activate a radio alarm to inform any receiving units of its location and that it has been tampered with.

Alternatively the alarm could be sounded unless the chip has received a coded signal indicating that it has reached its delivery location.

As well as the buzzer alarm function the chip uses the GPS system to determine its location and continually generates a signal containing this information. A concerned person may use an appropriate receiving device to locate the cargo that has been lost or tampered-with.

Another use of the associated electronics is to achieve a buddy system. The transmitter constantly or intermittently transmits a coded signal unique to the particular cargo closure. This may be picked up by the receiver in nearby similarly equipped cargo closures. The chip regularly, for example every five to ten minutes, registers incoming signals and compares them to codes stored in the memory which identify accompanying cargo containers. If a cargo container is not present for three consecutive scans the chip activates the buzzer alarm. A less intrusive alarm is sounded than for the tampering case, and the alarm may be turned of by depressing the button three times in quick succession. The chip stores information regarding when it was separated from and when it was reunited with cargo closures in the random access memory.

Data sensed and transduced by the accelerometer sensor are also recorded 15 by the electronic chip 41. They can be used to ascertain if the cargo has been subjected to rough handling.

At the end of the journey the recipient of the cargo container activates the closure and downloads the information regarding the journey details to a central data-basing system. The recipient generates a coded signal which when received by the cargo container deactivates the security features. In this way the cargo may be easily and conveniently be kept safe and the likelihood of security problems and other mishaps reduced. Furthermore any actual mishaps can be registered and located rapidly which is of great assistance in taking any remedial action or tracing and apprehending culprits.

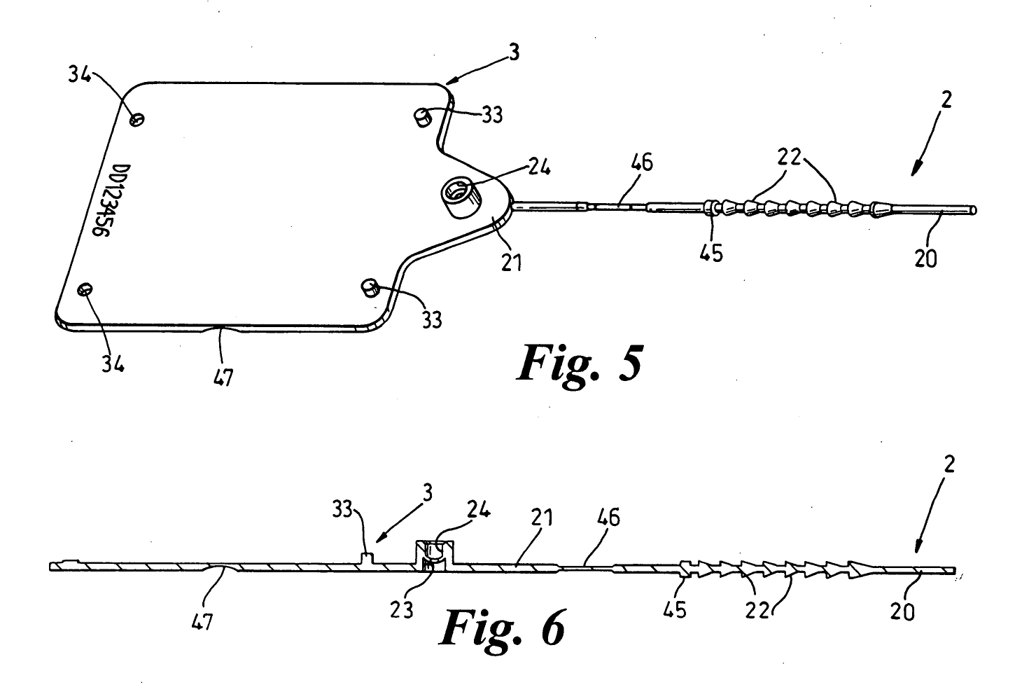

FIGS. 5 and 6 shows schematically a third embodiment of the cargo closure, which displays several further innovative structural features. As best seen in FIG. 5 the strap 20 of the tie 2 is an elongate cylindrical shape and barbs 22 are each constituted as a frusto-conical rib extending around the cylinder. These barbs 22 engage in a respective circular protrusion in a pawl member 23, when the stem 20 is inserted into a hole 24, containing the pawl member 23.

Once the stem 20 has been passed through the pawl member 23, it is held on all sides by the pawl member and is therefore difficult to remove. As best seen in FIG. 6 the distance between the pawl member 23 and the top of the hole 24 exceeds the length of one barb 22 so that an engaged barb 22 cannot be mechanically released from the pawl member 23.

Spaced axially from the barbs 22 towards the tab 21 end of the stem 20 is a lug 45. The lug 45 is a molded cylinder of greater diameter than the stem 20. It is stepped from the stem 20 at substantially 90°. When the stem 20 is inserted into the hole 24 and pulled through until all the barbs 22 have engaged with and passed through the pawl member 23, the lug 45 then engages the pawl member 23.

The lug 45 prevents further movement of the item 20 through the hole 24 as the inserting force is applied across the diameter of the lug 45 on the outer edges of the pawl member 23. Protrusions on the pawl member 23 therefore do not bend to allow the lug 45 through.

Spaced axially from the lug 45 and the barbs 22 towards the tab 21 end of the stem 20 is a molded neck formation 46. This neck formation 46 is a cylinder of smaller diameter than the bulk of the stem 20 and thus limits the maximum tensile force that may be applied to the stem 20 before plastic deformation or rupture of the neck 46 occurs. It constitutes a zone of weakness in the stem. Any deformation or breaking of the stem 20 would indicate that the cargo closure has been tampered with.

Placement of the neck 45 between the lug 45 and the tab means that high force is not applied to the neck 46 while the user inserts the barbs 22 through the pawl member 23. Any attempt to reverse this process, however, would entail the application of a withdrawal force to the neck 46 which is designed to break if the withdrawal force is above a predetermined value.

As best seen in FIG. 6 the reduction in the diameter of the stem 20 that comprises the neck 46 is symmetrical with respect to the diameter of the stem 20.

The median part of the data carrying tag also contains a zone of weakness 47. At this zone of weakness 47 the thickness of the data carrying tag 3 is reduced. The data carrying tag 3 may therefore be easily folded, the fold being established in the zone of weakness 47. This fold may be secured by insertion of studs 33 into holes 34.

The zone of weakness 47 is not symmetrical, the narrowing of thickness occurring on what will be the outer face of the data carrying tag when that is folded. The user will therefore find that tag folds naturally to cover any personal information affixed to its inner face.

The zone of weakness 47 may be orientated at any angle to the bulk of the tag 3 with appropriate placement of studs 33 and holes 34.

It is envisaged that such cargo closures could be supplied to airline passengers and other travelers in packs containing a number related to the number of people traveling together, there being sufficient for outward and return journeys together with a few spare closures in case of last- minute re-opening of luggage, and to allow for the purchase of additional luggage items.

The use of cargo closures in accordance with the invention, in particular, on air travelers' luggage, provides a simple and effective means of discouraging unauthorized tampering with items of luggage at any time between original closure of the luggage and reclaiming of the luggage after travel.

Given the large number of possible colors in which a cargo closure could be molded from polymeric material, the large number of logos which could be incorporated, and the large number of alpha-numeric sequences which could be applied, it is envisaged that breaking and replacement of the closure with an apparently identical closure would present the criminal with insuperable difficulties. If the closure were not replaced, its absence would be immediately apparent, and the fact that the luggage or other cargo item had been tampered with could be reported immediately to an appropriate authority.

It will also be appreciated that unique identifiers for cargo items could be fed to a data store with location and time information to enable tracking of cargo items, for example on a global scale. It is envisaged that the data or some of the data could be made available on the Internet, for example on payment of a fee, to enable the movement of cargo items to be tracked by their owners.

1. A cargo closure for sealing a cargo item in a closed condition comprising a tie and a data carrying member, the tie being permanently closable in the sense that once closed, the tie cannot easily be opened without rupturing the tie, and being adapted to secure the data carrying member to a said cargo item, wherein the data carrying member comprises a flag having a median zone of weakness about which the flag is foldable selectively to conceal or reveal data carried thereby.

2. A cargo closure according to claim 1 wherein said tie comprises a stem and a member having an opening into which the stem may be inserted, the stem and opening comprising co-operating surface formations adapted and arranged to allow insertion of the stem into the opening and to resist the stems withdrawal therefrom.

3. A cargo closure according to claim 2 wherein the stem comprises a zone of weakness.

4. A cargo closure according to claim 3 wherein the ultimate tensile strength of the zone of weakness is below the force required to withdraw the stem from the opening.

5. A cargo closure according to claim 2 wherein the stem comprises a stop means operative to limit insertion of the stem into the opening.

6. A cargo closure according to claim 2 wherein the surface formations comprise a series of axially spaced ribs and such ribs are of a generally saw-toothed shaped profile.

7. A cargo closure according to claim 6 wherein said ribs extend around said stem in substantially circular manner.

8. A cargo closure according to claim 7 wherein a said co-operating surface formation on said opening is spaced from each end of that opening by an amount which is greater than the axial spacing of said ribs.

9. A cargo closure according to claim 1 wherein the tie and the data carrying member are constituted by an integral molding of thermoplastics material.

10. A cargo closure according to claim 2 wherein the stem includes a strip of conductive material.

11. A cargo closure according to claim 10 wherein releasable snap-fit means are provided for holding the foldable data carrying member in folded condition.

12. A cargo closure according to claim 10 wherein the folded data carrying member constitutes a pocket for retaining a removable data carrier.

13. A cargo closure according to claim 12 wherein the removable data carrier comprises integrated circuit means.

14. A cargo closure according to claim 1 wherein some or all of the data is in the form of one or more visually legible characters.

15. A cargo closure according to claim 1 wherein some or all of the data is in machine readable form.

16. A travel pack comprising a travel document and at least one cargo closure according to claim 1.

17. A travel pack according to claim 16 wherein the travel document is a travel ticket.

18. A travel pack according to claim 16 wherein the travel document contains information selected from the group consisting of:
(a) ownership information
(b) an identification reference indicator
(c) operator information
(d) advertising information
(e) cargo handling information
(f) cargo contents information
(g) cargo delivery information
(h) passenger travel information

19. A cargo item comprising two components which are relatively movable to open the cargo item, and a cargo closure according to claim 1.

20. A cargo item according to claim 19 wherein at least one of the relatively movable components comprises part of a zip fastening device.

21. A cargo security system comprising a memory means adapted to store data relating to a cargo item, and a cargo closure according to claim 1, the cargo closure comprising a data carrier which comprises a flag adapted to carry visually legible data and a tie adapted to secure the data carrier to the cargo item; the data carrier bearing a reference location indicator which gives an indication of an address, in said memory means, of data pertaining to the cargo item to which that data carrier is, or is intended to be, affixed.

22. A cargo security system according to claim 21 wherein the reference location indicator is visually legible.

23. A cargo security system according to claim 21 wherein the memory means comprises a computer and the cargo closure comprises a reprogrammable memory means and means is provided for transferring data between the memory means of the computer and the memory means of the cargo closure.

24. A cargo security system according to claim 23, wherein the cargo closure further comprises activating means for the memory means, and deactivating means for the memory means in order to define the period in which data may be recorded.

25. A cargo according to claim 23 wherein the cargo closure comprises trigger operable signalling means.

26. A cargo security system according to claim 24 wherein a radio receiver is provided for triggering said signalling means.

27. A cargo closure for sealing a cargo item in a closed condition comprising a tie and a data carrying member which comprises a flag adapted to carry visually legible data and having a median zone of weakness about which the flag is foldable selectively to conceal or reveal any such data carried thereby, the tie being permanently closable in the sense that once closed, it cannot easily be opened without rupturing it and being adapted to secure the data carrying member to the cargo item, the data carrying member further comprising memory means adapted to store data in digital form.

28. A cargo closure according to claim 27 wherein the memory means comprises a magnetic storage medium.

29. A cargo closure according to claim 27 wherein the memory means is reprogrammable.

30. A cargo closure according to claim 27 further comprising: a transmitter adapted to emit a signal containing data; a receiver adapted to receive a signal containing data; a clock; a processor adapted to control the transmitter, the clock and the memory means.

31. A cargo closure according to claim 27 wherein the cargo closure is operatively associated with:
a transmitter adapted to emit a signal containing data;
a receiver adapted to receive a signal containing data;
a clock; and
a programmable memory adapted to store the data; and the cargo closure comprises:
a processor adapted to control the transmitter, the clock and the memory.

32. A cargo closure according to claim 27 wherein the clock, the processor and the memory means are located on an integrated circuit and the integrated circuit is located on a smart card, the smart card further comprising input and output means.

33. A cargo security system comprising a plurality of cargo closures according to claim 27 each attachable to a respective cargo item containing part of a cargo consignment wherein each transmitter, each receiver, each programmable memory, each clock and each processor are separately either associated with the cargo closure or the cargo item and the system periodically reaffirms that each cargo item remains with the rest of the cargo consignment, stores this information and provides an indication if the cargo consignment is no longer complete.

34. A method of advertising, the method comprising: displaying advertising material on a data carrier attached to a cargo closure, the cargo closure comprising a permanently closeable tie and the data carrier connecting the cargo closure to a cargo container, the data carrying member comprising a flag having a median zone of weakness about which the flag is foldable selectively to conceal or reveal data carried thereby.

35. A method of advertising according to claim 34 wherein the advertising material is on a label which is stuck to the data carrier.
